(19) United States
(12) Patent Application Publication
(10) Pub. No.: US 2013/0066588 A1
(43) Pub. Date: Mar. 14, 2013

(54) Agility Training and Assessment

(71) Applicant: Lance Sherry, Fairfax, VA (US)

(72) Inventor: Lance Sherry, Fairfax, VA (US)

(21) Appl. No.: 13/232,058

(22) Filed: Sep. 14, 2011

(51) Int. Cl. G06F 15/00

(52) U.S. Cl. 702/150

(57) ABSTRACT

A controller communicates a series of commands to a subject within a control area. A control area sensor generates movement data by monitoring the movement of the subject executing the command. Rebound surface sensor(s) generate contact data by monitoring contacts with rebound surface(s) resulting from the subject executing the commands. Performance of the subject is analyzed using the movement data and the contact data.

### BACKGROUND

Agility, the ability to change the body's position efficiently in response to changes in the environment may be an important skill, especially in sports. Agility involves the integration of isolated movement skills using a combination of balance, coordination, speed, reflexes, strength, endurance and stamina. A significant part of agility is the decision-making component. This is frequently not discussed or taught in agility development programs. For example, in the game of soccer, complex individual ball control skills and decision-making may be important to the success of a player. Foundational soccer skills for competitive players include the ability of a player to receive a pass from one direction, control the ball and change direction, and make a pass in a new direction. During the execution of these motor skills, the player makes decisions on where to pass the ball and with what velocity. Part of the decision-making is the interpreting both aural cures (e.g. team-mate calling for the ball) and visual cues (e.g. location of the team-mate relative) to make the decisions. These decisions have to be integrated in the motor skills

Currently, players are assessed in scrimmage and game situations. This type of assessment is not a controlled experiment and may involve receiving the ball from a limited range of direction and passing the ball to another limited range. Further, this type of assessment may be subject to poor inter-rater reliability.

Currently, there is no easy way for players to develop these skills through practice in a manner that provides instantaneous feedback that can be used to make adjustments, practice and improve these skills

### BRIEF DESCRIPTION OF THE SEVERAL VIEWS OF THE DRAWINGS

FIG. 1 is diagram of a player assessment and training configuration as per an aspect of an embodiment of the present invention.

FIG. 2 is diagram of a player assessment and training configuration as per an aspect of an alterative embodiment of the present invention.

FIG. 3 is diagram of a player assessment and training configuration as per an aspect of an alterative embodiment of the present invention.

FIG. 4 is block diagram of a player assessment and training architecture as per an aspect of an embodiment of the present invention.

FIG. 5 is an illustration of an example graphical user-interface for a setup window as per an aspect of an embodiment of the present invention.

FIG. 6 is an illustration of an example graphical user-interface for an assessment window as per an aspect of an embodiment of the present invention.

FIG. 7 is an illustration of an example user-interface for a feedback/analysis window as per an aspect of an embodiment of the present invention.

FIG. 8 is a flow diagram illustrating a controller process as per an aspect of an embodiment of the present invention.

FIG. 9 is a system diagram illustrating an aspect of an embodiment of the present invention.

### DETAILED DESCRIPTION OF EMBODIMENTS

Embodiments of the present invention help individuals develop agility skills such as rapid body movements with change of velocity or direction in response to a stimulus, as well as the decision-making skills

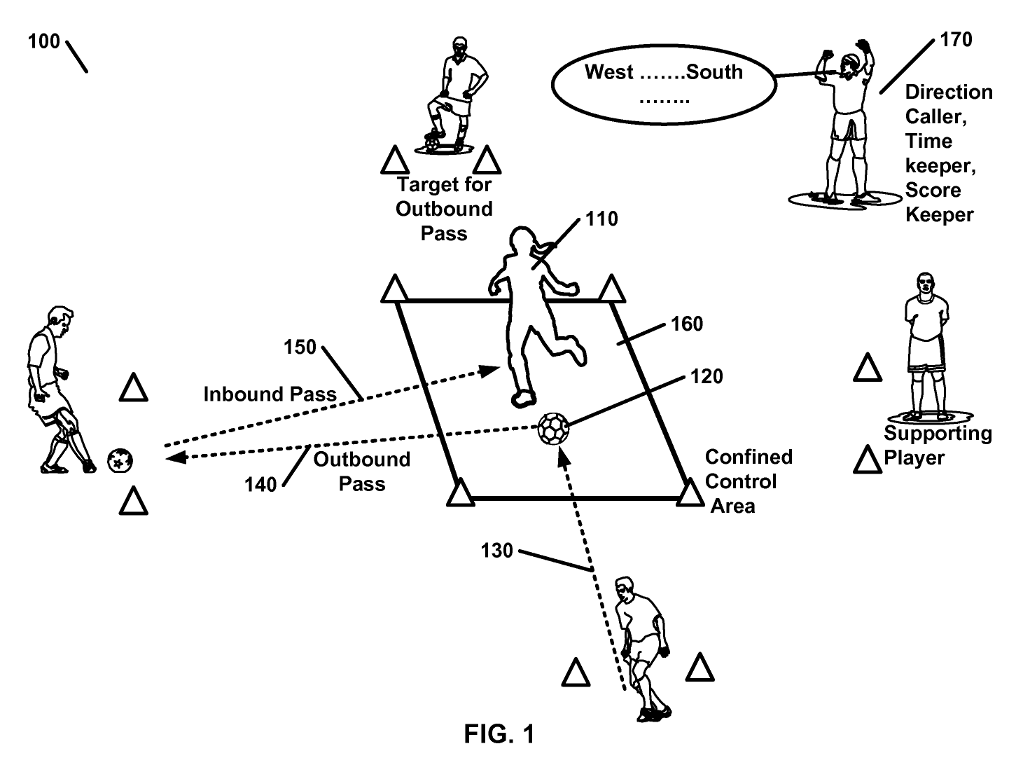

FIG. 1 is diagram of player assessment and training configuration 100 as per an aspect of an embodiment of the present invention. According to embodiments, player assessment provides a player 110 in a confined area 160 in which to receive a ball 120 from a first direction 130, turn, and make a pass 140 in a second direction. Once the pass 140 is made in the second direction, a return pass 150 may be received from that second direction. If the outbound pass 140 is not accurate or incorrectly weighted, the inbound pass 150 may be outside the confined area 160. In this situation, the player 110 retrieves the ball 120, using rapid foot skills, to the confined area 160 before making the next pass. The direction of the next pass may be determined by an outside entity 170 (i.e. team-mate). The direction of the next pass may be identified before the inbound pass 150 is made.

The player assessment may be based on the number of correct passes made within a specified time window (e.g. 3 minutes). The greater the number of passes, the greater the players foot and decision-making skills are rated. Poor performance by a player may be the result of: (i) an inaccurate (direction and/or speed) outbound pass 140, (ii) poor control of the inbound pass 150, (iii) slow turning mechanics, (iv) slow interpretation of the visual and aural signals, (v) incorrect direct decision-making resulting in incorrect direction of the outbound pass 140 or (vi) a combination thereof or the like. Improved performance may be achieved by analysis of the performance data to isolate these elements of the skill In this assessment/skill development embodiment, scoring may be manual.

In this embodiment, five assistants may be needed: four team-mates (181, 182, 182 and 184) to rebound the ball 120 and a direction caller/time keeper/score keeper 170. Assistant 170 (sometimes using a timer and clipboard) may be required to keep track of the time, and call out, in a random manner, directions to make the next pass. This configuration may result in inaccurate assessment, as the scores of the assessed players may be a function of the performance of their team-mates. The task of direction calling, time keeping and score-keeping may be a high workload task that could be executed poorly. The direction decision-making may be driven only by aural signals (not visual). Further, the detailed time keeping of the elements of the skill may be prohibitive for the time keeper.

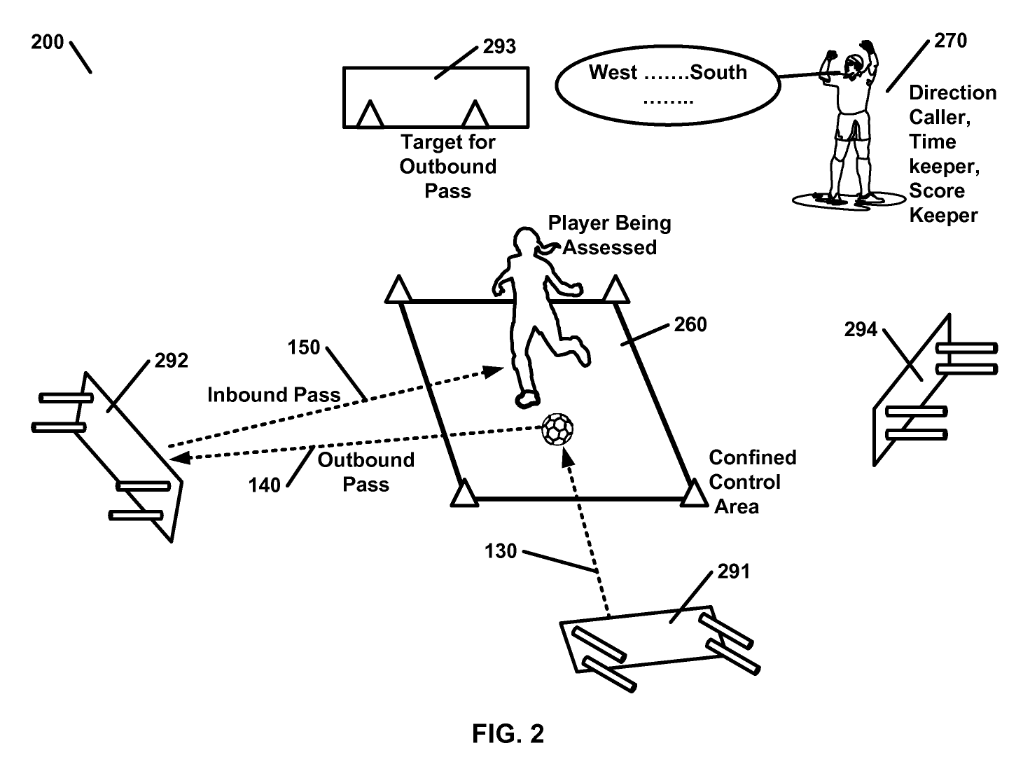

FIG. 2 is diagram of player assessment and training configuration 200 as per an aspect of an alterative embodiment of the present invention. Four tables (or benches) 291, 292, 293 and 294 may be arranged on their sides a prescribed distance from a centrally identified box (or circle). The table-tops 291, 292, 293 and 294 may be labeled with a target area generally located in the middle of the tables 291, 292, 293 and 294. The tables 291, 292, 293 and 294 may be positioned such that an accurate pass from the central box 260 results in a rebound back into box 260. An assistant 270 with a timer and clipboard may be required to keep track of the time, and call out, in random manner, directions to make the next pass. This configuration may result in inaccurate assessments if the tables 291, 292, 293 and 294 are not arranged correctly and/or are not stable. The task of direction calling, time keeping and score-keeping may be a high workload task that could be executed poorly. The direction decision-making may be driven only by aural signals (not visual). Further, the detailed time keeping of the elements of the skill may be prohibitive for the time keeper.

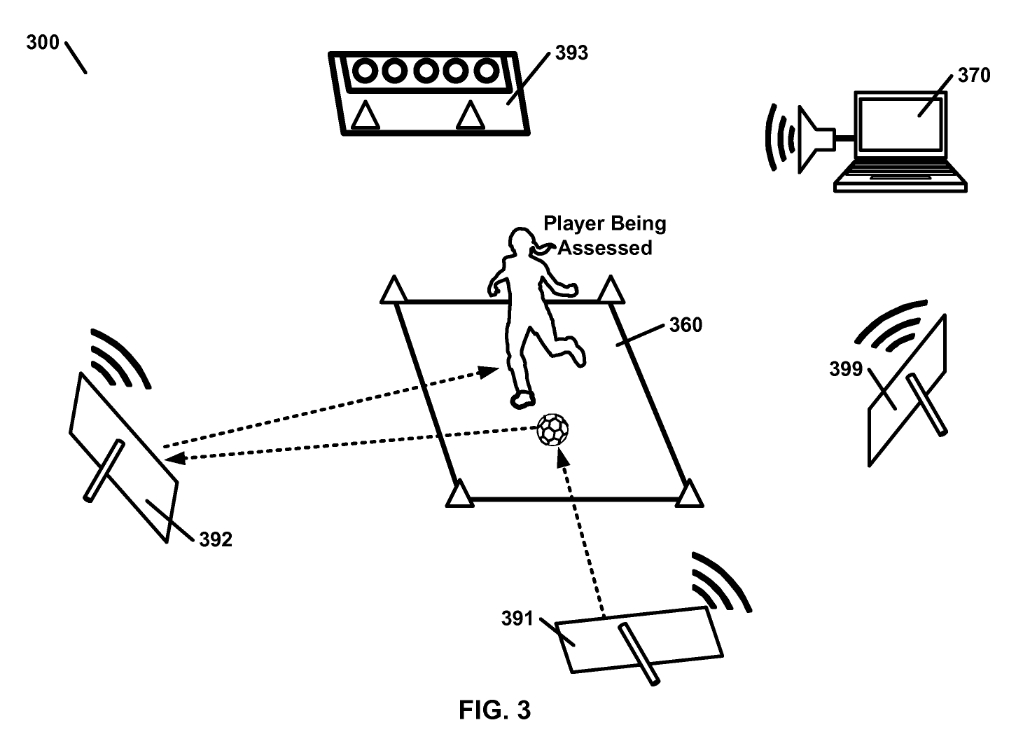

FIG. 3 is diagram of player assessment and training configuration 300 as per an aspect of an alterative embodiment of the present invention. This configuration arranged to assess soccer player ball control skills and decision-making. However, one skilled in the art will recognize that this configuration may be utilized to assess other ball control skills and decision-making such as baseball or basketball passing control skills and decision-making.

Configuration 300 is arranged to provide a reliable mechanism to assess player agility (i.e. motor skills and decision-making skills) in the receipt of an inbound pass, change direction, and accurate outbound pass. Embodiments of the invention provide: (1) a structured environment to enable skill assessment of player(s) (such as reliable inbound pass); (2) instantaneous feedback of performance to enable efficient player improvement; and (3) a breakdown of performance to isolate and identify elements of the skill that need to be improved.

Physical components of the system include (but are not limited to): (1) a confined control area mat 360, a multitude of rebound walls (391, 392, 393, . . . 399), and a control console 370.

According to embodiments, the confined control area mat 360 may have a multitude of embedded pressure sensors. According to embodiments, the control area mat 360 may also include a communications system to interconnect sensor data to other devices. The communications system may be a wired communications system or a wireless communications system. Wireless communications systems may use radio communications, 802-11 communications, Bluetooth communications, infrared communications or the like.

Rebound walls (391, 392, 393, . . . 399) may include, but are not limited to: adjustable target(s), pressure sensor(s), and/or visual indicator(s) (i.e. light panel). The rebound walls (391, 392, 393, . . . 399) may be mounted in a manner that can handle the force of a pass. Additionally, rebound walls (391, 392, 393, . . . 399) may include communication system(s) such as wireless communication system(s).

Control console 370 may be configured to receive setup data, manage assessment exercises and provide analysis and feedback. According to some embodiments, control console 370 may include mechanisms to communicate with players such as a loudspeaker, audio communications, visual communications and the like. Control console 370 may be configured to communicate with confined control area mat 360 and some or all of the multitude of rebound walls (391, 392, 393, . . . 399). This communications may use wired or wireless communications.

The control console 370 may utilize a specialized computing machine to manage assessment exercises and provide analysis and feedback. Alternatively, the control console 370 may utilize a series of non-transient computer readable instructions on a machine readable medium to cause one or more processors to manage assessment exercises and provide analysis and feedback. The one or more processors may reside in any number of devices such as specialized computing machine, a computer, a laptop, an electronic tablet, a smart phone, or the like.

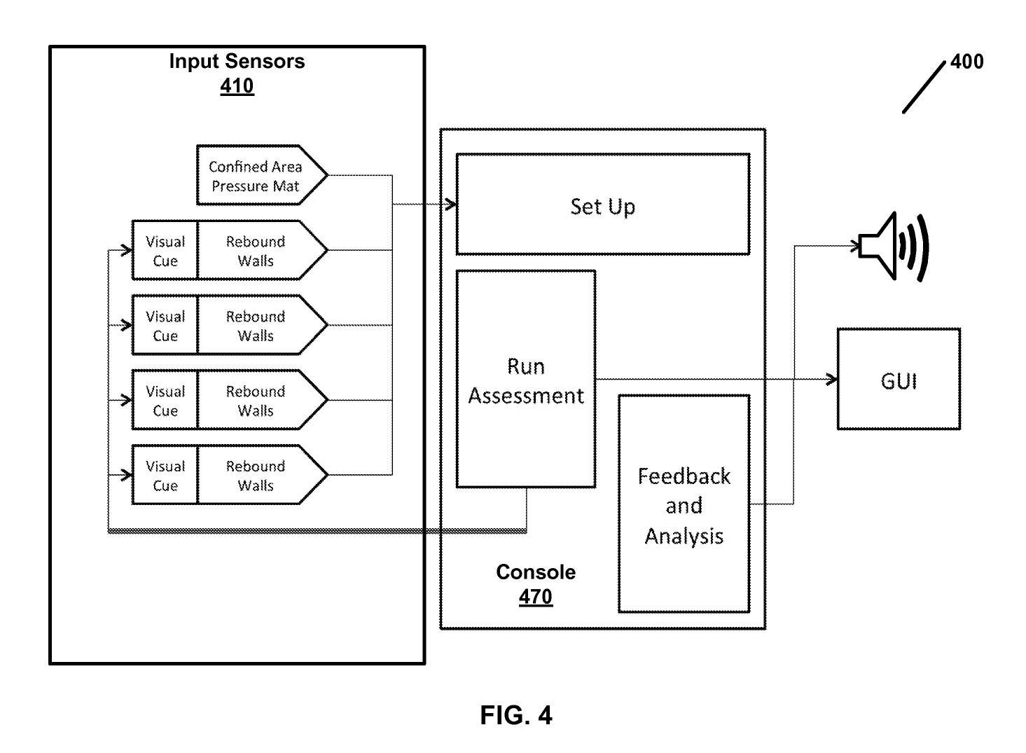

FIG. 4 is a block diagram of the player assessment and training architecture 400 as per an aspect of an embodiment of the present invention. As shown in this example, there are two types of input sensors 410: confined control area sensors 420 and rebound wall sensors 430.

The confined control area sensors 420 may be configured to monitor the movements of a player in a confined area. To that end, many types of sensors may be utilized such as pressure sensors attached to a mat, optical sensors, or the like.

Similarly, the rebound wall sensors 430 may be configured to assess contact of playing instrument(s) such as a ball all with a rebound wall. Examples of such sensors include pressure sensors, pressure mats, contact switches, optical sensors, or the like.

Various types of output deices may be used to communicate with a player. For example, a loudspeaker may be used to communicate aural direction cues. Visual cues to direct direction commands may be attached to rebound walls,

Console 470 may include a graphical user-interface.

According to some embodiments, there may be multiple modes of operation such as a setup mode, an assessment mode, a feedback and analysis mode, a combination mode or the like.

A Setup mode may accept inputs for: the number of rebound walls, the distance and directions of the rebound walls from the Confined Control Area, the size of the Confined Control Area, the mapping of the rebound walls, the nomenclature for the rebound walls (e.g. “north”, “tennis courts”, “green”), or the like. The Setup mode may accept inputs for the duration of the test (e.g. 3 minutes).

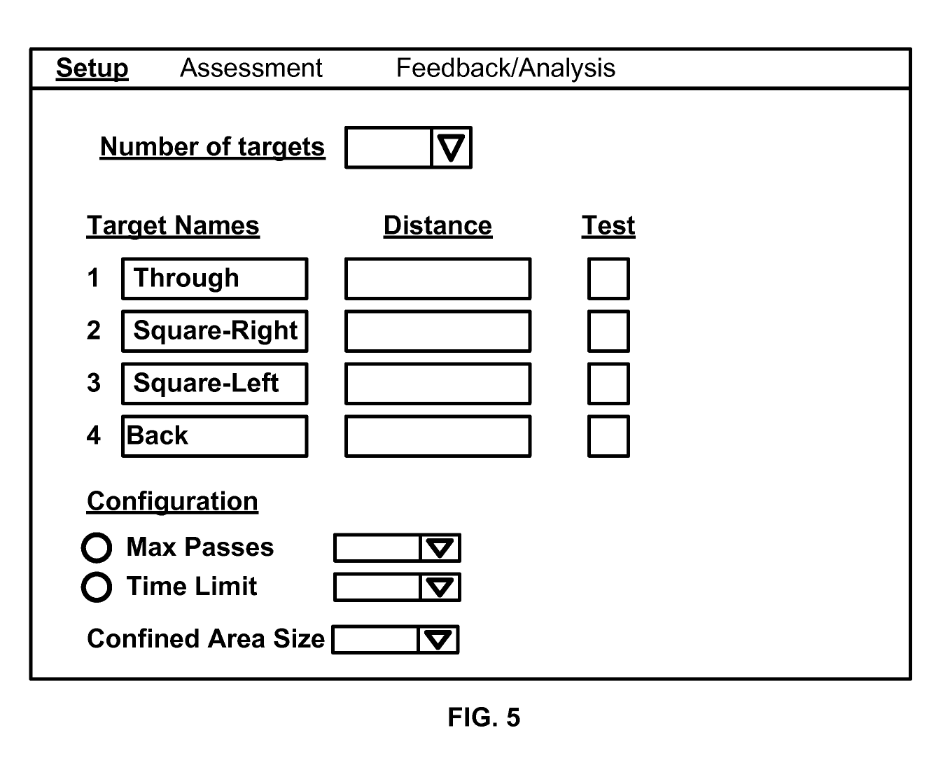

FIG. 5 is an illustration of an example graphical user-interface for a setup window as per an aspect of an embodiment of the present invention.

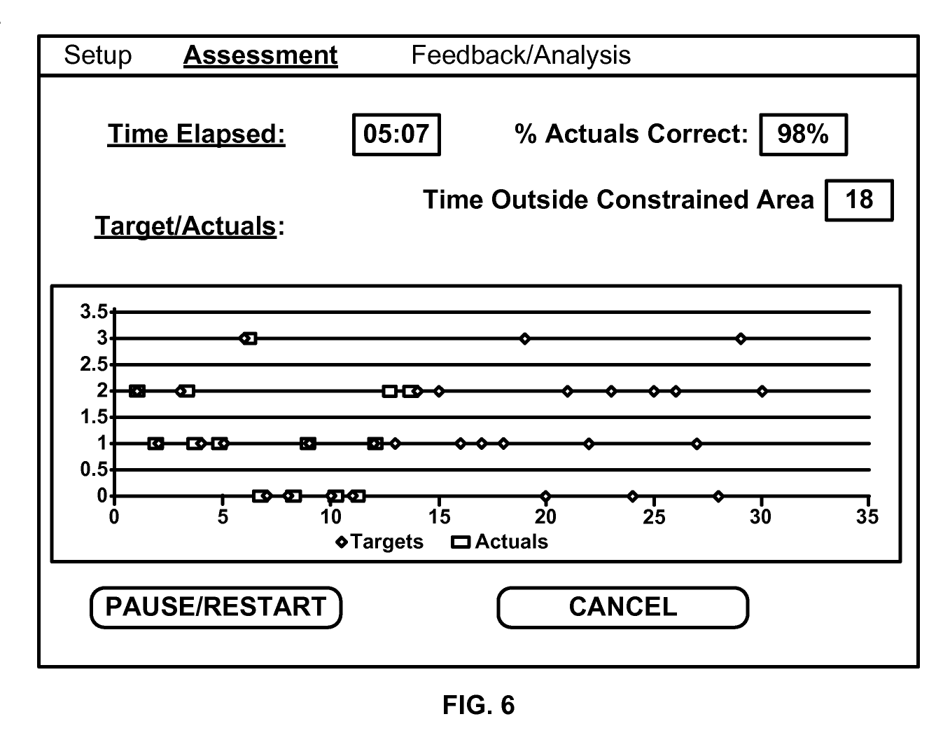

FIG. 6 is an illustration of an example graphical user-interface for an assessment window as per an aspect of an embodiment of the present invention. According to some embodiments, assessment mode(s) may provides feedback on the connectivity of the system and visual counts of progress of the assessment.

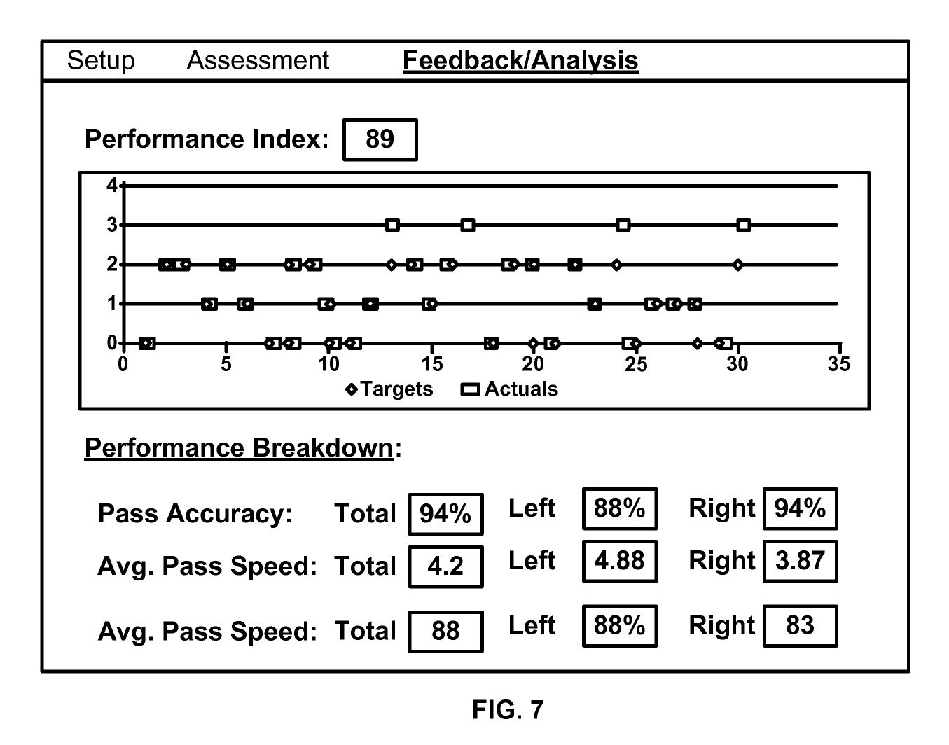

FIG. 7 is an illustration of an example user-interface for a feedback/analysis window as per an aspect of an embodiment of the present invention. The Feedback and Analysis mode may be configured to provide statistical analysis of a players performance. Performance statistics may be provided for an overall assessment. Performance statistics may be provided for each element of a skill, for each direction and magnitude of a turn, for accuracy. Pass visualizations may be displayed. A breakdown of the foot pressure may be made available for individual maneuvers.

Examples of other statistics include: longitudinal temporal statistics for individual players, longitudinal temporal statistics for a group of players (e.g. a team); or the like.

Embodiments of the present invention may provide at least the following benefits: (1) assessment of a player's individual performance on passing-receiving -turning-passing skills, (2) feedback on the elements of various skills (including footwork, passing mechanics, and decision-making); (3) instantaneous feedback; (4) objective assessment of a player that is not reliant on team-mates or coaching staff; (5) objective assessment of a player without inter-rater reliability issues; or the like.

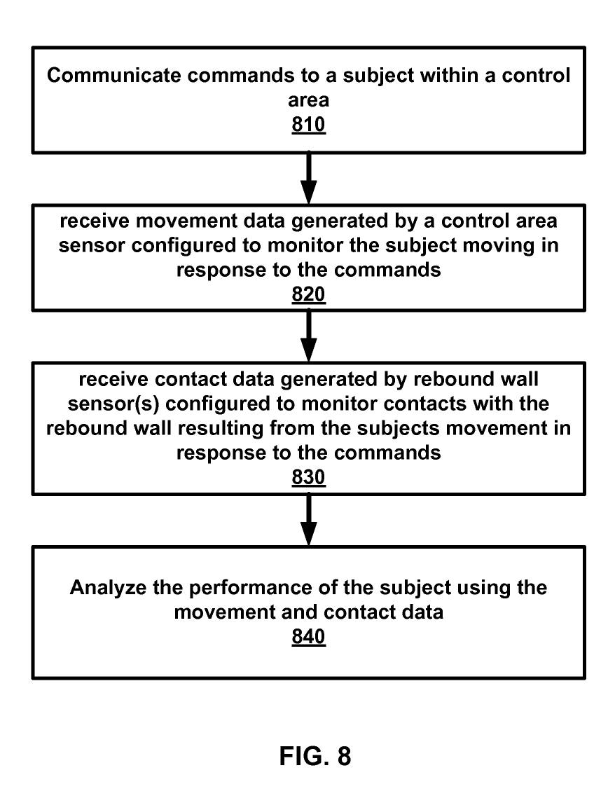

FIG. 8 is a flow diagram illustrating an example controller process as per an aspect of an embodiment of the present invention. In some embodiments, the flow diagram may be implemented as a non-transient computer readable medium having machine readable instructions configured to cause one or more processors to perform a process for agility training and assessment. The non-transient computer readable medium may include, but is not limited to, solid state memory devices, floppy disks, cloud storage or the like. The machine readable instructions may be compiled instructions, interpreted instructions or the like. The one or more processors may include microcontrollers, microprocessors and associated hardware or software in combination with hardware or the like. The one or more processors may be part of a custom device or part of a computing device such as a computer, a laptop, a smart phone, an electronic pad, a PDA, a combination of the above, or the like.

At 810, commands may be communicated to a subject within a control area. A subject may be a person being trained or evaluated with respect to an agility skill In some embodiments, the subject could be an animal such as a dog being trained or evaluated with respect to agility, desired behaviors, or the like. The commands may include agility related instructions such as kick a ball into target A, throw a ball against target B, turn left, or the like.

Commands may be communicated using at least one of the following: speaker(s), light emitting device(s), headset(s), combinations of the above, or the like. The speakers may be loudspeakers driven by devices such as a microphone, sound synthesizer or the like. Light emitting devices may include devices such as flashing lights, color lights, displays boards, or the like. Headphones may be wired or wireless. Wireless headphones may be connected to transceiver such as a walkie-talkie, a cell phone, or the like.

The control area may be a physically constrained area that a subject operates out of when attempting to execute the commands.

Movement data may be generated by a control area sensor configured to monitor a subject moving in response to the commands at 820. In some embodiments, the control area sensor monitors the movements inside the control area. However, one skilled in the art will recognize that other embodiments could also monitor movements that leave the control area. For example, a subject may be instructed to receive a ball, pivot left and kick the ball into a target. If the subject has difficulty executing that commend within the control area, it may be useful to continue monitoring the motions as the subject leaves the control area.

The control area sensor may include device(s) configured to monitor various body motions such as foot maneuvers, hand maneuvers, or the like. For example, a shoe position sensor may be used to detect foot placement. Shoe sensor's may be obtained from Futek Advanced Sensor Technologies Inc. of Irvine, Calif. Motion sensors, including optical motion sensors, such as can be found from Meta Motion of San Francisco, Calif. may be used to monitor the motion of all or parts of the body and appendages. Control area sensors may also be fashioned by establishing an array if pressure sensors to detect the motion of the feet. To build this array, one may use pressure mats, dance mats, safety mats or pressure sensitive alarm mats to instrument a sensor area. One skilled in the art will recognize that combinations of the above may also be used to detect motion within embodiments of the invention.

At 830, contact data may be generated by rebound surface sensor(s) configured to monitor contacts with a rebound surface resulting from the subject moving in response to the commands. The rebound surface sensor(s) may be mounted on rebound surface(s). The rebound surface(s) may include backstops, benches, nets, walls, targets, combinations thereof or the like. A target may be mounted on the rebound surface. According to some embodiments, contacts may be generated by a ball hitting rebound surface. The rebound surface may include at least one of the following types of sensors: pressure sensor(s), accelerometer(s), optical tracking sensor(s) and/or associated system(s), triangulation tracking system(s), combinations of the above, or the like.

The performance of the subject may be analyzed at 840 using movement data and/or contact data. The performance may be calculated using statistic(s). Examples of statistic(s) calculations may include average calculations, mean calculations, standard deviation calculations, frequency calculations, percentage calculations, combination calculations or the like. The statistics may be used to summarize the collected movement and contact data by describing what was observed in the sample numerically or graphically. Additional calculations may uses patterns in the data to draw inferences about the subject. These inferences may include estimates, associations within the data, correlations and relationships. The data may be used to determine future exercises and associated commands to help the subject improve their agility skills

The performance data maybe displayed on a display. This data may also be used in further data analysis or used to define future training/exercise/evaluation sessions.

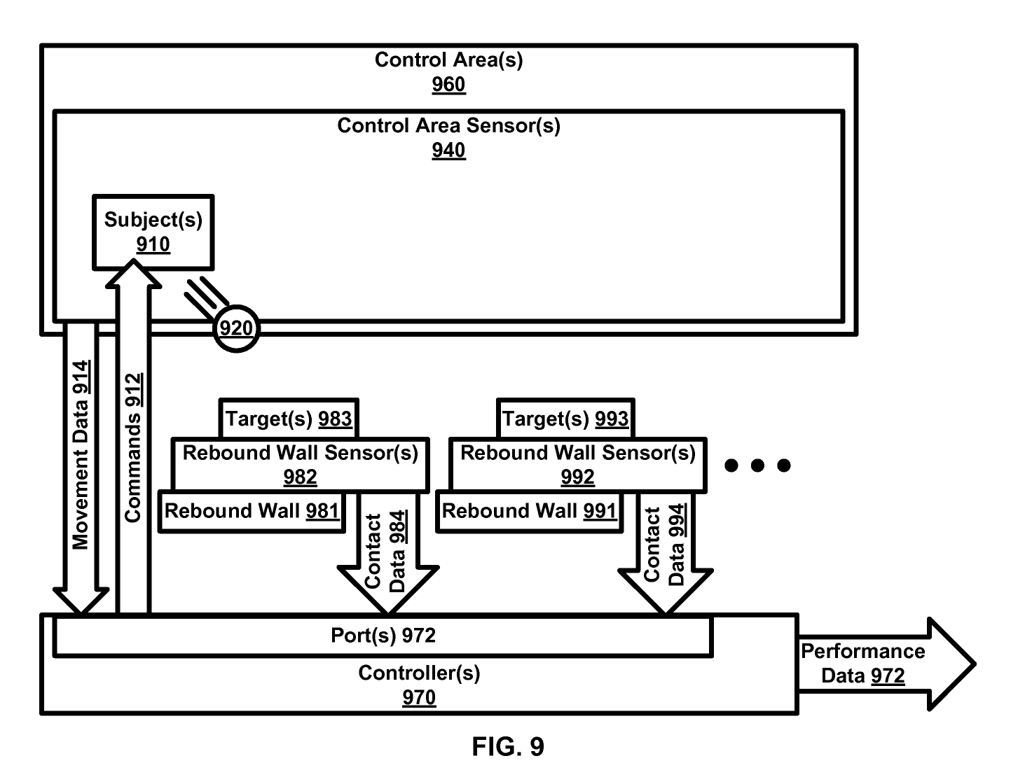

FIG. 9 is a system diagram illustrating an aspect of an embodiment of the present invention. As shown, the system includes a controller(s) 970, control area sensor(s) 940, and rebound sensors(s) 982 . . . 992.

Controller 970 may be configured to: communicate a series of commands 912 to a subject 910 within a control area 960 and analyze the performance of subject 910 using movement data 914 and contact data 984 . . . 994. The controller 970 may communicate, at least in part, using wireless communications such as Bluetooth, 802.11, cellular, RF, a combination thereof or the like. In some embodiment, controller 970 may be a multitude of controllers. The multitude of controllers may be linked and in some cases may share data.

Command(s) 912 may be communicated using loud speaker(s), light emitting device(s), headset(s), combinations thereof or the like. Control area sensor(s) 940 may be configured to generate the movement data 914 by monitoring the movement of the subject 910 executing the commands 912. Examples of control area sensor(s) include: shoe position sensor(s), appendage position sensor(s), pressure mat(s), optical position sensor(s), weight sensor(s), combinations of the above, or the like.

The rebound surface sensor(s) 982 . . . 992 may be configured to generate contact data 984 . . . 994 by monitoring contacts with any of the rebound surface(s) 981 . . . 991 resulting from subject 910 executing commands 912. The rebound surface sensor(s) 982 . . . 992 may use switches, pressure sensors, optical sensors, combinations thereof or the like.

Rebound surface sensor(s) 982 . . . 992 may be mounted on rebound surface(s) 981 . . . 991. These rebound surface(s) 981 . . . 991 may include a surface that is configured to be contacted by objects such as balls, hands, feet, Frisbees, paws or the like. Target(s) 983 . . . 993 may be mounted on rebound surface(s) 981 . . . 991 or on the rebound wall sensor(s) 982 . . . 992. In some embodiments, combinations of the target(s) 983 . . . 993, rebound wall sensor(s) 982 . . . 992 and rebound surface(s) 981 . . . 991 may be combined.

Additionally, the system may include a display performance data. The data may be displayed using a GUI interface. Example GUI interfaces are shown in FIGS. 5-7.

Controller(s) 970 may include port(s) 972. One function of port(s) 972 may be to communicate a series of commands 912 to a subject 910 within a control area 960 through a command transducer. Examples of command transducer(s) include: speaker(s), light emitting device(s), headset(s), combinations thereof or the like.

Port(s) 972 may also receive movement data from control area sensor(s) 940. Control area sensor(s) 940 may be configured to monitor the movement of subject 910 attempting to execute command(s) 912.

Port(s) 972 may also receive contact data from rebound surface sensor(s) 982 . . . 992 configured to monitor contacts with rebound surface(s) 981 . . . 991 resulting from subject 910 attempting to execute commands 912.

Controller(s) 970 may include performance analyzer(s) configured to analyze the performance of subject 910 using movement data 914 and contact data 984 . . . 994. Controller(s) 970 may include a display or other input output accessories to assist in data entry and/or data presentation.

Port(s) 972 may use wired or wireless communication to talk to the various sensors and other devices such as printers, headsets or the like.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e. hardware with a biological element) or a combination thereof, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW, MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of assessing and training soccer players. However, one skilled in the art will recognize that embodiments of the invention could be used to train and assess other skills for other types of individuals or groups of individuals. For example, embodiments of the present invention may be directed to physical therapy. Additional embodiments may be directed to training and/or assessing players for other sports such as baseball or basketball. In yet another example embodiment, the claimed invention may be configured to train or assess a multitude of individuals together in a common training area. A benefit of this equivalent configuration, is the ability to track and assess group agility.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A non-transient computer readable medium having machine readable instructions configured to cause one or more processors to perform a process comprising:
a. communicating commands to a subject within a control area;
b. receiving movement data generated by a control area sensor configured to monitor the subject moving in response to the commands;
c. receiving contact data generated by at least one rebound surface sensor configured to monitor contacts with a rebound surface resulting from the subject movement in response to the commands; and
d. analyzing the performance of the subject using:
i. the movement data: and
ii. the contact data.

2. The medium according to claim 1, wherein the control area sensor is at least one of the following:
a. a shoe position sensor;
b. an appendage position sensor;
c. a pressure mat;
d. an optical position sensor;
e. a weight sensor; or
f. a combination of the above.

3. The medium according to claim 1, wherein the control area sensor measures foot maneuvers.

4. The medium according to claim 1, wherein the contacts are generated by a ball hitting the rebound surface.

5. The medium according to claim 1, wherein the performance is calculated using a statistic.

6. The medium according to claim 1, wherein the one or more processors are part of at least one of the following:
a. a computer;
b. a smart phone;
c. an electronic pad;
d. a special purpose device; or
e. a combination of the above.

7. The medium according to claim 1, wherein at least one of the at least one rebound surface sensor is at least one of the following:
a. pressure sensor;
b. an accelerometer;
c. an optical tracking system;
d. a triangulation tracking system; or
e. a combination of the above.

8. The medium according to claim 1, wherein at least one of the at least one rebound surface sensor is mounted on at least one of the at least one rebound surface.

9. The medium according to claim 1, further including displaying the performance.

10. The medium according to claim 1, wherein at least one of the at least one rebound surface includes at least one target.

11. The medium according to claim 1, wherein the commands are communicated using at least one of the following:
a. at least one speaker;
b. at least one light emitting device;
c. a headset; or
d. a combination of the above.

12. A system comprising:
a. a controller configured to:
i. communicate a series of commands to a subject within a control area;
ii. analyze the performance of the subject using:
1. movement data; and
2. contact data;
b. a control area sensor configured to generate the movement data by monitoring the movement of the subject executing the commands; and
c. at least one rebound surface sensor configured to generate the contact data by monitoring contacts with at least one rebound surface resulting from the subject executing the commands.

13. The system according to claim 12, wherein the control area sensor is at least one of the following:
a. a shoe position sensor;
b. an appendage position sensor;
c. a pressure mat;
d. an optical position sensor;
e. a weight sensor; or
f. a combination of the above.

14. The system according to claim 12, wherein the controller communicates at least in part using wireless communications.

15. The system according to claim 12, wherein at least one of the at least one rebound surface sensor is a pressure sensor.

16. The system according to claim 12, wherein at least one of the at least one rebound surface sensor is mounted on at least one of the at least one rebound surface.

17. The system according to claim 12, further including a display.

18. The system according to claim 12, further including at least one target configured to be mounted on at least one of the at least one rebound surface.

19. The system according to claim 12, wherein the commands are communicated using at least one of the following:
a. at least one speaker;
b. at least one light emitting device;
c. a headset; or
d. a combination of the above.

20. An apparatus comprising:
a. a port configured to:
i. communicate a series of commands to a subject within a control area through a command transducer;
ii. receive movement data from a control area sensor configured to monitor the movement of the subject executing the commands; and
iii. receive contact data from at least one rebound surface sensor configured to monitor contacts with at least one rebound surface resulting from the subject executing the commands; and
b. a performance analyzer configured to analyze the performance of the subject using:
i. the movement data; and
ii. the contact data.

21. The apparatus according to claim 20, wherein the control area sensor is at least one of the following:
a. a shoe position sensor;
b. an appendage position sensor;
c. a pressure mat;
d. an optical position sensor;
e. a weight sensor; or
f. a combination of the above.

22. The apparatus according to claim 20, wherein the port uses wireless communications.

23. The apparatus according to claim 20, wherein at least one of the at least one rebound surface sensor is a pressure sensor.

24. The apparatus according to claim 20, wherein at least one of the at least one rebound surface sensor is mounted on at least one of the at least one rebound surface.

25. The apparatus according to claim 20, further including a display.

26. The apparatus according to claim 20, further including at least one target configured to be mounted on at least one of the at least one rebound surface.

27. The apparatus according to claim 20, wherein the command transducer is at least one of the following:
a. at least one speaker;
b. at least one light emitting device;
c. a headset; or
d. a combination of the above.
